(19) United States
(12) Patent Application Publication
(10) Pub. No.: US 2012/0039188 A1
(43) Pub. Date: Feb. 16, 2012

(54) NETWORK CONECTION DEVICE AND METHOD FOR TESTING NETWORK PORTS OF THE NETWORK CONNECTION DEVICE

(75) Inventor: CHAO-TSUNG FAN, Tu-Cheng (TW)

(73) Assignee: HON HAI PRECISION INDUSTRY CO., LTD., Tu-Cheng (TW)

(21) Appl. No.: 13/040,282

(22) Filed: Mar. 4, 2011

(30) Foreign Application Priority Data
Aug. 11, 2010 (TW) 99126700

(51) Int. Cl. H04L 12/26

(52) U.S. Cl. 370/249

(57) ABSTRACT

A method tests network ports of a network connection device. Multiple port pairs of the network connection device are set. Each of the port pairs includes an external network port and an internal network port of the network connection device. Each internal network port is connected to a loopback device. For each port pair, a data packet is created and transmitted from the external network port of the port pair to the internal network port of the port pair. The data packet transmitted to the internal network port of the selected port pair is compared with a corresponding data packet returned from the internal network port of the selected port pair via the corresponding loopback device. A test result of the port pair is displayed by a display device to indicate whether data transfer of the port pair is normal.

### BACKGROUND

1. Technical Field

Embodiments of the present disclosure relate to electronic device test, and particularly to a network connection device and method for testing network ports of the network connection device.

2. Description of Related Art

A network connection device (e.g., a router or a network switch) includes external network ports that are used for data transfer over an extranet network, and internal network ports that are used for data transfer over an intranet network. A test device (e.g., a computer) may be utilized to test the network ports of the network connection device. The test device may control the network connection device to transfer data packets to and fro between the external network ports and the internal network ports, and test data transfer performance of the network ports. However, it is inconvenient to implement the network port test using such test device, and may cause test costs to increase.

### BRIEF DESCRIPTION OF THE DRAWINGS

FIG. 1 is a block diagram of one embodiment of a network connection device.

FIG. 2 is a block diagram of a test unit of the network connection device of FIG. 1.

FIG. 3 is a flowchart of one embodiment of a method for testing network ports of a network connection device, such as that of FIG. 1.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

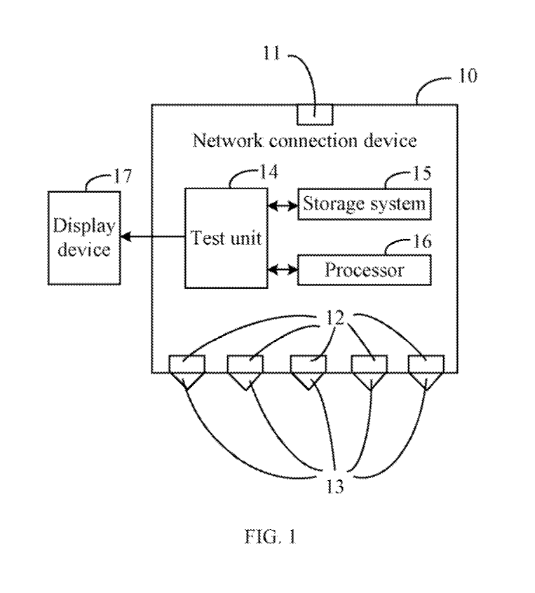

FIG. 1 is a block diagram of one embodiment of a network connection device 10. The network connection device 10 may be a router of a network switch, for example. The network connection device 10 includes one or more external network ports 11 and multiple internal network ports 12 (e.g., one external network port and five internal network ports as shown in FIG. 1). The external network ports 11 are used for data transfer over an extranet, such as the Internet. The internal network ports 12 are used for data transfer over an intranet, such as a local area network (LAN) of a company. The external network ports 11 can communicate with the internal network ports 12, so that data exchange is implemented between the intranet and the extranet. Each of the internal network ports 12 is connected to a loopback device 13. When an internal network port 12 receives data packets from an external network port 11, the loopback device 13 drives the internal network port 12 to return the data packets to the external network port 11. The network connection device 10 may be connected to a display device 17 to display test results of the network connection device 10.

In one embodiment, the network connection device 10 may further include a test unit 14, a storage system 15, and at least one processor 16. The test unit 14 includes a number of function modules. The function modules may comprise computerized codes in the form of one or more programs that are stored in the storage system 15. The computerized codes includes instructions that are executed by the at least one processor 16 to provide functions for the modules. In one embodiment, the storage system 15 may be an internal storage device, such as a random access memory (RAM) for temporary storage of information, and/or a read only memory (ROM) for permanent storage of information. In some embodiments, the storage system 15 may also be an external storage device, such as an external hard disk, a storage card, or a data storage medium.

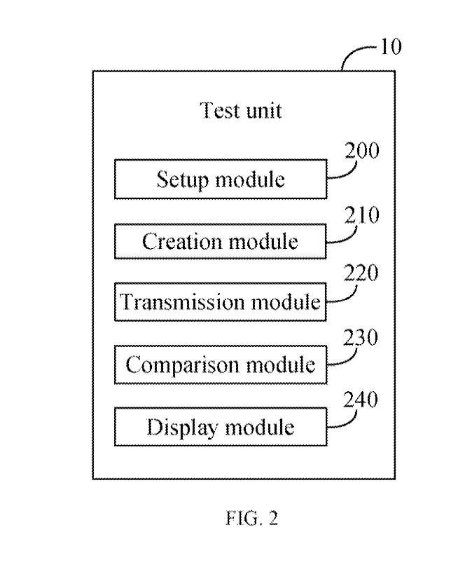

FIG. 2 is a block diagram of the test unit 14 of FIG. 1. In one embodiment, the test unit 14 may include a setup module 200, a creation module 210, a transmission module 220, a comparison module 230, and a display module 240.

The setup module 200 sets multiple port pairs of the network connection device 10. Each of the port pairs includes an external network port 11 and an internal network port 12. In one example with respect FIG. 1, the network connection device includes an external network port 11 (denoted as Port5) and five internal network ports 12 (denoted as Port0-Port4). The setup module 200 sets five port pairs of Port5-Port0, Port5-Port1, Port5-Port2, Port5-Port3, and Port5-Port4. In one embodiment, the setup module 200 may arrange the port pairs in a sequence. For example, the port pair of Port5-Port0 may be the first port pair in the sequence. The port pair of Port5-Port1 may be the second port pair in the sequence. The port pair of Port5-Port2 may be the third port pair in the sequence. The port pair of Port5-Port3 may be the fourth port pair in the sequence. The port pair of Port5-Port4 may be the fifth port pair in the sequence.

The creation module 210 creates a data packet. A data packet is a formatted unit of data transmitted over network and consists of control information and user data.

The transmission module 220 selects the port pairs one by one. For each of the selected port pairs, the transmission module 220 transmits the data packet from the external network port 11 of the selected port pair to the internal network port 12 of the selected port pair. For example, the transmission module 220 selects the port pair of Port5-Port0, and transmits the data packet from Port5 to Port0. In one embodiment, the transmission module 220 selects the port pairs according to the sequence.

The comparison module 230 determines whether data transfer of the selected port pair is normal by comparing the data packet transmitted to the internal network port 12 of the selected port pair with a corresponding data packet returned from the internal network port 12 of the selected port pair. As mentioned above, when a data packet is transmitted from an external network port 11 to an internal network port 12, the loopback device 13 connected to the internal network port 12 may drive the internal network port 12 to the return data packet to the external network port 11. If the data packet transmitted to the internal network port 12 of the selected port pair is identical to the corresponding data packet returned from the internal network port 12 of the selected port pair, the comparison module 230 determines that the data transfer of the selected port pair is normal. Otherwise, if the data packet transmitted to the internal network port 12 of the selected port pair is not identical to the corresponding data packet returned from the internal network port 12 of the selected port pair, the comparison module 230 determines that the data transfer of the selected port pair is abnormal.

The display module 240 controls the display device 17 to display a test result of the selected port pair. In one embodiment, the display device 17 includes multiple LED indicators. Each of the LED indicators corresponds to one of the port pairs. If data transfer of the selected port pair is normal, the display module 240 lights up a corresponding LED indicator with green. Otherwise, if the data transfer of the selected port pair is abnormal, the display module 240 lights up the corresponding LED indicator with red. The display module 240 may light up all the LED indicators with green if the data transfer of all the port pairs is normal.

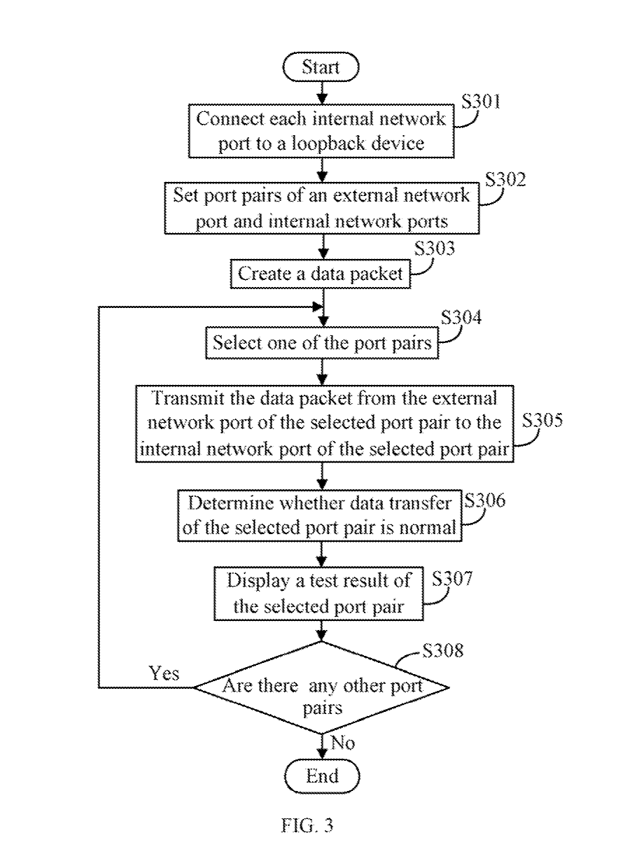

FIG. 3 is a flowchart of one embodiment of a method for testing network ports of a network connection device, such as that of FIG. 1. The method may test data transfer between the external network ports 11 and the internal network ports 12 of the network connection device 10. Depending on the embodiments, additional blocks may be added, others removed, and the ordering of the blocks may be changed.

In block S301, each of the internal network ports 12 of the network connection device 10 is connected to a loopback device 13.

In block S302, the setup module 200 sets port pairs of the network connection device 10. Each of the port pairs includes an external network port 11 and an internal network port 12. In one example, the network connection device 10 includes an external network port Port5 and five internal network ports Port0-Port4. The setup module 200 sets five port pairs of Port5-Port0, Port5-Port1, Port5-Port2, Port5-Port3, and Port5-Port4.

In block S303, the creation module 210 creates a data packet. The data packet is in a predetermined format and consists of control information and user data.

In block S304, the transmission module 220 selects one of the port pairs. For example, the transmission module 220 selects the port pair of Port5-Port0. In one embodiment, the transmission module 220 selects the port pairs according to a predetermined sequence.

In block S305, the transmission module 220 transmits the data packet from the external network port 11 of the selected port pair to the internal network port 12 of the selected port pair. For example, the transmission module 220 transmits the data packet from Port5 to Port0.

In block S306, the comparison module 230 compares the data packet transmitted to the internal network port 12 of the selected port pair with a corresponding data packet returned from the internal network port 12 of the selected port pair via a corresponding loopback device 13, to determine whether data transfer of the selected port pair is normal. If the data packet transmitted to the internal network port 12 of the selected port pair is identical to the corresponding data packet returned from the internal network port 12 of the selected port pair, the comparison module 230 determines that the data transfer of the selected port pair is normal.

In block S307, the display module 240 controls the display device 17 to display a test result of the selected port pair. In one embodiment, the display module 240 may further display a total test result of all the selected port pairs if the data transfer of all the port pairs is normal.

In block S308, the transmission module 220 determines if there are any other port pairs that have not been selected. If there are any other port pairs that have not been selected, the flow may return to block S304. If there are no other port pairs to be selected, the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A network connection device, comprising:
one or more external network ports;
a plurality of internal network ports, each of the internal network ports being connected to a loopback device;
a storage system;
at least one processor; and
one or more programs stored in the storage system and executable by the at least one processor, the one or more programs comprising:
a setup module operable to set port pairs of the network connection device, each of the port pairs comprising one of the external network ports and one of the internal network ports;
a creation module operable to create a data packet;
a transmission module operable to select the port pairs one by one, and transmit the data packet from the external network port of the selected port pair to the internal network port of the selected port pair;
a comparison module operable to determine whether data transfer of the selected port pair is normal by comparing the data packet transmitted to the internal network port of the selected port pair with a corresponding data packet returned from the internal network port of the selected port pair via a corresponding loopback device; and
a display module operable to control a display device connected to the network connection device to display a test result of the selected port pair.

2. The network connection device of claim 1, wherein the network connection device is a router or a network switch.

3. The network connection device of claim 1, wherein the port pairs are arranged and selected in a sequence.

4. The network connection device of claim 1, wherein the display device comprises multiple LED indicators, each of which corresponds to one of the port pairs.

5. The network connection device of claim 4, wherein the display module lights up the corresponding LED indicator with green if the data transfer of the selected port pair is normal, and lights up the corresponding LED indicator with red if the data transfer of the selected port pair is abnormal.

6. A method for testing network ports of a network connection device, the method comprising:
(a) setting port pairs of the network connection device, each of the port pairs comprising one of the external network ports and one of the internal network ports of the network connection device, each of the internal network ports being connected to a loopback device;
(b) creating a data packet;
(c) selecting one of the port pairs;
(d) transmitting the data packet from the external network port of the selected port pair to the internal network port of the selected port pair;
(e) determining whether data transfer of the selects port pair is normal by comparing the data packet transmitted to the internal network port of the selected port pair with a corresponding data packet returned from the internal network port of the selected port pair via the loopback device;
(f) controlling a display device to display a test result of the selected port pair; and
(g) repeating block (c) to block (f) until all the port pairs have been selected.

7. The method of claim 6, wherein the network connection device is a router or a network switch.

8. The method of claim 6, wherein the port pairs are arranged and selected in a sequence.

9. The method of claim 6, wherein the display device comprises multiple LED indicators, each of which corresponds to one of the port pairs.

10. The method of claim 9, wherein the block (f) comprises:
lighting up the corresponding LED indicator with green if the data transfer of the selected port pair is normal; and
lighting up the corresponding LED indicator with red if the data transfer of the selected port pair is abnormal.

11. A non-transitory storage medium having stored thereon instructions that, when executed by a processor of a network connection device, causes the network connection device to execute a network port test method, the method comprising:
(a) setting port pairs of the network connection device, each of the port pairs comprising one of external network ports and one of internal network ports of the network connection device, each of the internal network ports being connected to a loopback device;
(b) creating a data packet;
(c) selecting one of the port pairs;
(d) transmitting the data packet from the external network port of the selected port pair to the internal network port of the selected port pair;
(e) determining whether data transfer of the selects port pair is normal by comparing the data packet transmitted to the internal network port of the selected port pair with a corresponding data packet returned from the internal network port of the selected port pair via a corresponding loopback device;
(f) control a display device to display a test result of the selected port pair; and
(g) repeating block (c)to block (f) until all the port pairs have been selected.

12. The medium of claim 11, wherein the network connection device is a router or a network switch.

13. The medium of claim 11, wherein the port pairs are arranged and selected in a sequence.

14. The medium of claim 11, wherein the display device comprises multiple LED indicators, each of which corresponds to one of the port pairs.

15. The medium of claim 14, wherein the block (f) comprises:
lighting up the corresponding LED indicator with green if the data transfer of the selected port pair is normal; and
lighting up the corresponding LED indicator with red if the data transfer of the selected port pair is abnormal.
